(19) United States
(12) Patent Application Publication
(10) Pub. No.: US 2026/0302801 A1
(43) Pub. Date: Oct. 1, 2026

(54) SOLAR TONNEAU COVER

(71) Applicant: Toyota Motor Engineering & Manufacturing North America, Inc., Plano, TX (US)

(72) Inventors: Alexander W. Schuyler, Ann Arbor, MI (US); Jarod Duncan, Brighton, MI (US); Eric Chow, Ypsilanti, MI (US); Saeed D. Heydari, Plano, TX (US); Madeleine D. Steele, Prosper, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/091,635

(22) Filed: Mar. 26, 2025

(51) Int. Cl. H02J 7/35; B60J 7/14; B60L 53/51; B60R 11/00; B60R 16/033

(52) U.S. Cl. CPC H02J 7/35; B60J 7/141; B60L 53/51; B60R 11/00; B60R 16/033; B60R 2011/004; B60R 2011/0059; B60R 2011/0078

(57) ABSTRACT

A tonneau cover for a truck bed may include one or more solar panels configured to convert sunlight into electricity. The electricity generated by the solar panels may be stored in one or more batteries within the truck. The solar panels may be directly integrated with the electronics of the truck such that energy generated by the solar panels may be accessible via a power port located in the truck bed or may be used directly by the internal battery of the vehicle to supply power to auxiliary functions. The solar tonneau cover can also be electrically and/or mechanically controlled to reposition itself as the vehicle is driven or is stationary to capture the most sunlight and energy for the vehicle. For a hybrid or electric vehicle, power generated by the solar panels may be used to power the vehicle and/or extend the range of the vehicle.

### BACKGROUND

### 1. Field

The present disclosure is directed generally to tonneau covers for vehicles, and more particularly to vehicle tonneau covers with solar energy features.

### 2. Description of the Related Art

A standard tonneau cover is typically a hard or soft cover that spans the back of a pickup truck. The cover can protect the truck bed and its contents from weather, improve the aerodynamics of the vehicle, and improve the safety of the truck bed contents. Standard tonneau covers may be soft and made from flexible materials such as fabric or vinyl or may be hard and made from rigid materials such as fiberglass, aluminum, or various composites. Tonneau covers may be retractable and use a mechanism that rolls the cover into a housing when not in use. Other tonneau covers may be made of multiple connected panels that allow the cover to be folded. Regardless of design variations, tonneau covers provide a large substantially flat surface that can be better utilized to increase functionality.

Trucks use power to run and are constantly becoming more efficient due to increasingly efficient technologies. Electricity is used to power a variety of auxiliary features on a gas-powered vehicle, and potentially all features including powering the vehicle itself on an electric vehicle. A tonneau cover that can harvest solar power and convert solar energy into usable electricity for the truck can make the truck more efficient, saving time and/or money for the driver or user of the truck over time.

Therefore, there is a need for systems, vehicles, and methods for using solar tonneau covers that can harvest solar power.

### SUMMARY

A tonneau cover for a truck bed may include one or more solar panels configured to convert sunlight into electricity. The electricity generated by the solar panels may be stored in one or more batteries within the truck. The solar panels may be directly integrated with the electronics of the truck such that energy generated by the solar panels may be accessible via a power port located in the truck bed or may be used directly by the internal battery of the vehicle to supply power to auxiliary equipment systems. The solar tonneau cover can also be electrically and/or mechanically controlled to reposition itself as the vehicle is driver to capture the most sunlight and energy for the vehicle. A light, sun, or heat sensor may be used to determine the sun's position relative to the vehicle and then a motor can adjust the solar tonneau cover to be directed at the sun to capture the maximum amount of sunlight based on the data received from the sensor regarding the sun's position. For a hybrid or electric vehicle, power generated by the solar panels may be used to power the vehicle and/or extend the range of the vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a vehicle with a solar tonneau cover according to an aspect of the present disclosure;

FIGS. 2A and 2B illustrate a vehicle with a foldable solar tonneau cover according to an aspect of the present disclosure;

FIGS. 3A and 3B illustrate a vehicle with an adjustable solar tonneau cover according to an aspect of the present disclosure;

FIG. 4A illustrates a tonneau cover attached to a truck bed via rails according to an aspect of the present disclosure;

FIG. 4B illustrates a tonneau cover attached to a truck bed via rails and a latch mechanism according to an aspect of the present disclosure;

FIG. 4C illustrates a tonneau cover attached to a truck bed via rails with a lowered lift mechanism according to an aspect of the present disclosure;

FIG. 4D illustrates a tonneau cover attached to a truck bed via rails with a raised lift mechanism according to an aspect of the present disclosure;

FIG. 4E illustrates solar panels attached to a tonneau cover via a clamp according to an aspect of the present disclosure;

FIG. 4F illustrates solar panels attached to a tonneau cover via a bolt according to an aspect of the present disclosure;

FIGS. 5A and 5B illustrate a vehicle with a hinged solar tonneau cover according to an aspect of the present disclosure;

FIG. 5C illustrates a vehicle with a solar tonneau cover and switch contacts according to an aspect of the present disclosure;

FIGS. 6A and 6B illustrate a vehicle with a solar tonneau cover according to an aspect of the present disclosure; and

FIG. 7 illustrates a vehicle with a battery, a backup battery, and a solar tonneau cover according to an aspect of the present disclosure.

### DETAILED DESCRIPTION

The systems, vehicles, and methods described herein support a more energy-efficient vehicle and support CO₂ emission reduction of vehicles through powering vehicle functions with a clean and renewable energy source. The vehicle may be a truck or other vehicle with a space that can be covered by a tonneau cover or other covering or paneling. The vehicle may include a solar tonneau cover, or a tonneau cover with solar panels able to convert sunlight into usable electricity for auxiliary use (e.g., electrical vehicle components) and/or main use (e.g., batteries to power the vehicle) by the vehicle.

The vehicle may be designed such that the solar tonneau cover is able to integrate with the electronics of the vehicle, including its battery. Energy generated from the solar tonneau cover may be used to charge an auxiliary battery that can be removed from the vehicle or may be used to power the vehicle's main battery. Energy generated by the solar tonneau cover may be used to support the use of auxiliary functions of the vehicle, including, for example, the use of a radio, an air conditioner or a head unit. The solar tonneau cover can also be electrically and/or mechanically controlled to reposition itself as the vehicle is driven to capture the most sunlight and energy for the vehicle. That is, a sun sensor may be used to determine the sun's position relative to the vehicle (i.e., the solar tonneau cover) and then adjust the solar tonneau cover to be directed at the sun to capture the maximum amount of sunlight. Ine one example, the sun sensor can determine a substantially perpendicular relationship between the sun's direct rays and the solar tonneau cover (e.g., one or more solar cells). For a hybrid or electric vehicle, the energy generated by the solar tonneau cover may be used to power the vehicle's hybrid or electric battery system, thereby providing power to the vehicle and/or adding additional range or time of use to the vehicle.

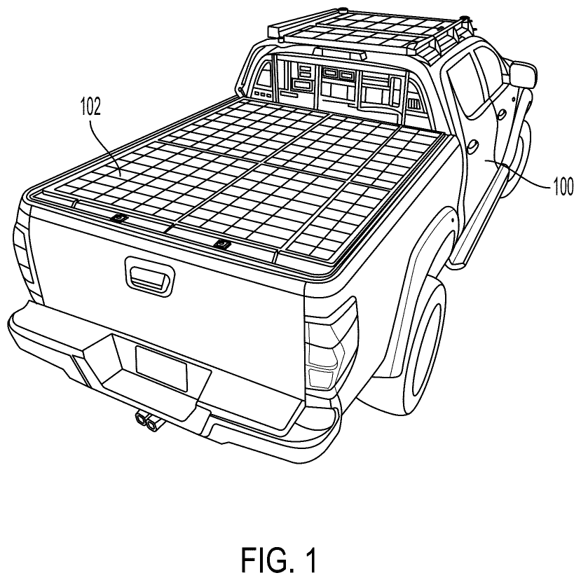

FIG. 1 illustrates a vehicle 100 with a solar tonneau cover 102. The vehicle 100 is a conveyance capable of transporting a person, an object, or a permanently or temporarily affixed apparatus. The vehicle 100 may be a truck or other vehicle with an open front or rear area, such as a truck bed, that can be covered by a tonneau cover or other similar paneling or covers.

The vehicle 100 may have an automatic or manual transmission. The vehicle 100 may be a self-propelled wheeled conveyance, such as a car, an SUV, a truck, a bus, a van or other motor or battery driven vehicle. The vehicle 100 may be powered by a traditional internal combustion engine. The vehicle 100 may be an electric vehicle, a hybrid vehicle, a plug-in hybrid vehicle, a fuel cell vehicle, or any other type of vehicle that includes a motor/generator. The vehicle 100 may be entirely electric and be powered solely by one or more batteries. The vehicle 100 may be non-autonomous, fully autonomous, or semi-autonomous. In some embodiments, the vehicle 100 may be operated in an autonomous, semi-autonomous, or fully driver-operated state. In that regard, the vehicle 100 may be operated independently of driver control and, from time to time, without a person inside the vehicle 100.

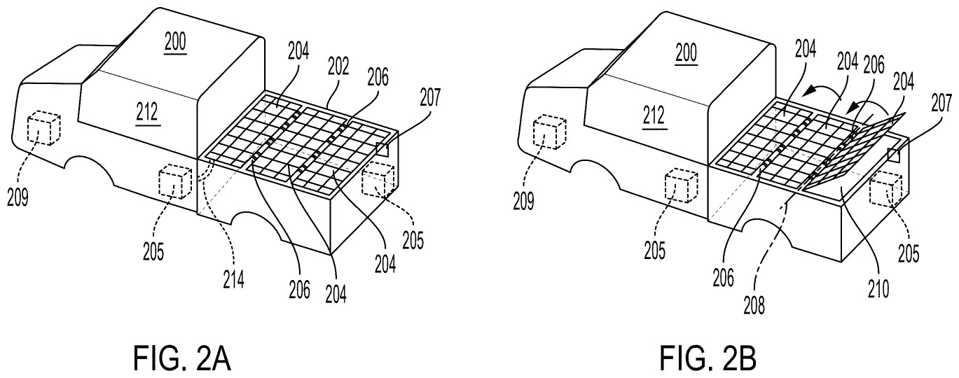

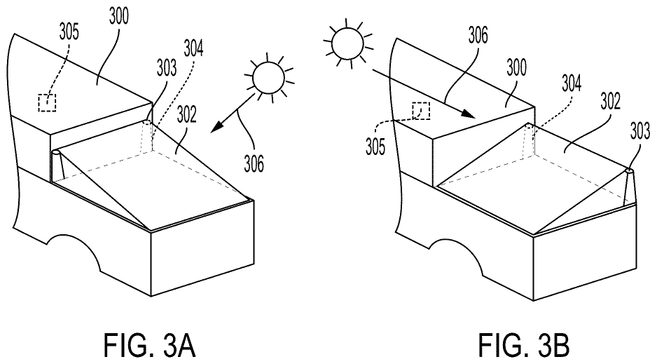

FIG. 2A illustrates a vehicle 200 with a foldable solar tonneau cover 202. FIG. 2B illustrates the vehicle 200 with the foldable solar tonneau cover 202 partially folded. The solar tonneau cover 202 may include two or more solar cell arrays 204, or solar panels, connected by hinges 206. The solar cell arrays 204 may extend horizontally, or left to right, across the width of the vehicle, as shown in FIGS. 2A and 2B. Alternatively, the solar cell arrays 204 may extend lengthwise, or front to back, across the tonneau cover 202, or may be placed in any other configuration. Each solar panel 204 may be controlled (i.e., adjusted or moved) independent of another solar panel or the solar panels may be controlled (i.e., adjusted or moved) as a group or a subgroup.

As shown in FIG. 2B, the foldable tonneau cover 202 is able to fold or bend along an axis 208 that runs through the one or more hinges 206 that connect two or more solar cell arrays 204. One or more solar cell arrays may be lifted or folded along an axis 208 to allow access to the interior of the truck bed 210. The solar cell array 204 may be folded along the axis 180 degrees to lay flat against an adjacent solar cell array 204. The one or more solar cell arrays may be lifted and folded lengthwise or widthwise of the truck bed 210.

In some aspects, the solar cell arrays 204 may be detachable from the tonneau cover 202. The solar cell arrays 204 may be detached from the tonneau cover 202 and able to be placed on the ground or elsewhere. For example, the detached solar cell arrays 204 may be placed on the ground at a camping site to power one or more batteries. The solar cell arrays 204 may still be able to be used to charge a battery on or external to the vehicle 200 when the solar cell arrays 204 are detached from the tonneau cover 202.

The vehicle 200 with the tonneau cover 202 may also have a wire harness 214 that attaches to the tonneau cover 202 and/or the solar cell arrays 204 and is configured to route energy generated from the tonneau cover 202 and/or the solar cell arrays 204 to a removable battery 205 located in the truck bed 210 or the truck cab 212. The wire harness 214 may route power into an auxiliary battery port 207 located in the truck bed 210 or the truck cab 212 or may route power directly to a main battery 209, such as a 12V battery, of the vehicle 200. The main battery 209 may be located within the front hood of the vehicle, as shown in FIG. 2A and FIG. 2B, or may be located elsewhere within the vehicle 200, such as within the truck cabin under the seats, on or adjacent to the vehicle chassis or other locations where batteries may be stored. The main battery 209 may be able to start the internal combustion engine of the vehicle 200 if the vehicle 200 has an engine or may be able to power the electric powertrain if the vehicle 200 is electric. The battery 209 may also be able to power auxiliary features of the vehicle 200. The tonneau cover 202 and/or the solar cell arrays 204 may have separate wire harnesses 214 that connect to the removable battery 205 housed in the truck bed 210 or truck cab 212. The removable battery 205 may have a dedicated compartment located in the truck bed 210 to securely house the removable battery 205. A charge level of the removable battery 205 may be maintained by the solar cell arrays 204 and/or the main battery 209 of the vehicle 200. A wiring strategy such as the wiring harness 214 for the removable battery 205 additionally allows for the ability to move the detachable solar cell arrays 204 and the removable battery 205 outside of the vehicle 200 and maintain their linkage elsewhere.

FIG. 3A illustrates a vehicle 300 with an adjustable solar tonneau cover 302. The solar tonneau cover 302 is able to be raised, lowered, and/or tilted via an adjustment electrical and/or mechanical mechanism 304 so that the solar tonneau cover 302 can be positioned at a favorable angle to sunlight 306 or at whatever angle is desired by the user of the ECU 305 of the vehicle 300. The adjustment electrical and/or mechanical mechanism 304 can be powered by the energy generated by the solar cell arrays 204 of the solar tonneau cover 302.

A heat or sun sensor 303 can be used to locate the sun and indicate to an electronic control unit (ECU) 305 the direction of the sun. The sensor 303 may be able to locate the sun through sensing light, heat, or other factors. The sensor 303 may be located on the surface of the solar tonneau cover 302, may be located at the corners of the solar tonneau cover 302, may be located on the roof of the cab of the vehicle 300, or may be located on any location where the sensor 303 is able to receive and sense heat or light. The sensor 303 may include multiple sensors located in multiple locations to provide better calculation of the sun's rays for more efficient capture of the sun's energy. For example, the sensor 303 may include sensors located toward the rear of the truck bed and sensors located toward the front of the truck bed, so that when portions of the truck bed are cast in shadow, sensor(s) 303 located in or on other portions of the truck bed are still able to sense light, heat, or other factors.

The ECU 305 can be used to control the adjustable solar tonneau cover 302 so that the solar cell arrays attached to the top of the solar tonneau cover 302 can be moved and directed towards the sun so that the solar cell arrays can receive maximum solar rays, thus maximizing the amount of energy captured by the solar cell arrays. As an example, the solar cell arrays can be adjusted to be perpendicular to the sun' rays.

FIG. 3B illustrates the vehicle 300 with the adjustable solar tonneau cover 302. As shown in FIG. 3B, the solar tonneau cover 302 can be positioned, using the adjustment mechanism 304 (e.g., motors, hydraulics, arms, hinges, etc.), in various positions in order to best capture sunlight 306. As shown in FIG. 3B, the adjustment mechanism 304 may be used to position the solar tonneau cover 302 such that a lengthwise edge of the solar tonneau cover 302 may be raised higher than an opposite lengthwise edge of the solar tonneau cover 302 such that the solar tonneau cover 302 is positioned at an incline from the left to the right of the vehicle 300.

The solar tonneau cover 302 may include several solar panels or may include only one solar panel. The solar panels(s) may be attached to and cover all or most of a top surface of the solar tonneau cover 302. The solar tonneau cover 302 may be connected to the adjustment mechanism 304 and may lay flat along the top of a truck bed when the adjustment mechanism 304 is not being used and may be able to be raised or lowered from at least one point along a perimeter of the solar tonneau cover 302 when the adjustment mechanism 304 is being used. As shown in FIGS. 3A and 3B, the solar tonneau cover 302 may be raised using the adjustment mechanism 304 to raise an edge of the solar tonneau cover 302 higher than an adjacent edge. This raising of the solar tonneau cover 302 may position the solar panel(s) on the surface of the solar tonneau cover 302 to better capture sunlight 306 as compared to if the solar tonneau cover 302 was left flat across the top of the truck bed.

The adjustment mechanism 304 may include an automated system or may require a user of the vehicle to physically or manually orient the solar tonneau cover 302. In some aspects, the adjustment mechanism 304 may include a mechanism that is configured to raise, lower, and/or tilt the solar tonneau cover 302. In some aspects, solar the tonneau cover 302 may be manually raised, lowered, tilted, and otherwise adjusted in its positioning. The adjustment mechanism 304 may use extendable rods powered by a motor, springs, or other mechanisms capable of extending a rod or a kickstand. In some aspects, the adjustment mechanism 304 may be coupled with one or more sensors (e.g., light, sun, heat, or other sensors) that can detect the presence, direction, and/or intensity of sunlight. The one or more sensors may be coupled to a computer or an ECU 305 capable of determining the best orientation of the solar tonneau cover 302 to best capture the sunlight 306. GPS data may also be used to determine the location of the vehicle 300 and a known location of the sun to best position the solar tonneau cover 302 using the adjustment mechanism 304. The computer or the ECU 305 may be configured to automatically position the solar tonneau cover 302 in an optimal position using the adjustment mechanism 304. The adjustment mechanism 304 may be used when the vehicle 300 is parked or otherwise not being driven. The adjustment mechanism 304 may also be used when the vehicle 300 is being driven to change the position and direction of the solar tonneau cover 302 as the vehicle 300 is driving or moving. The adjustment mechanism 304 may be able to be adjusted physically by a user of the vehicle 300 when the vehicle 300 is parked.

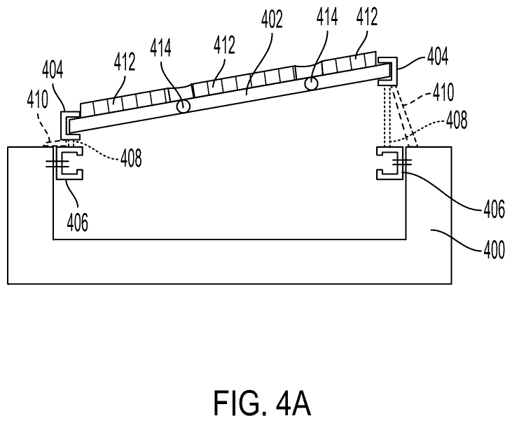

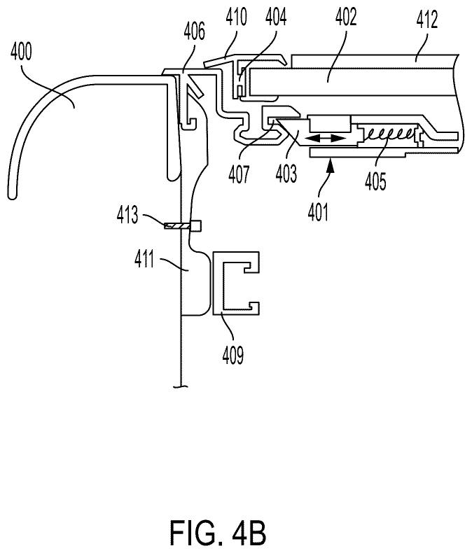

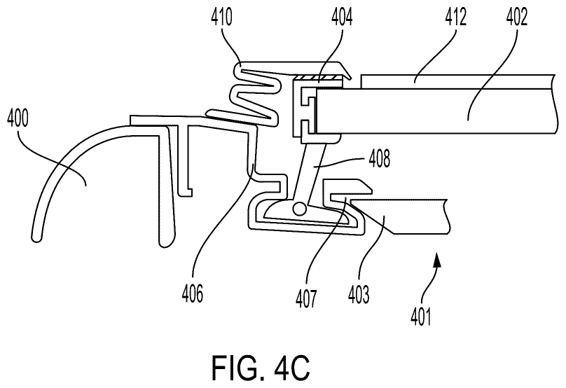

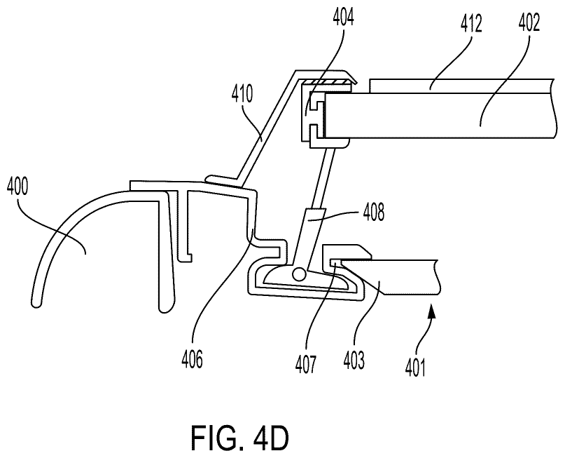

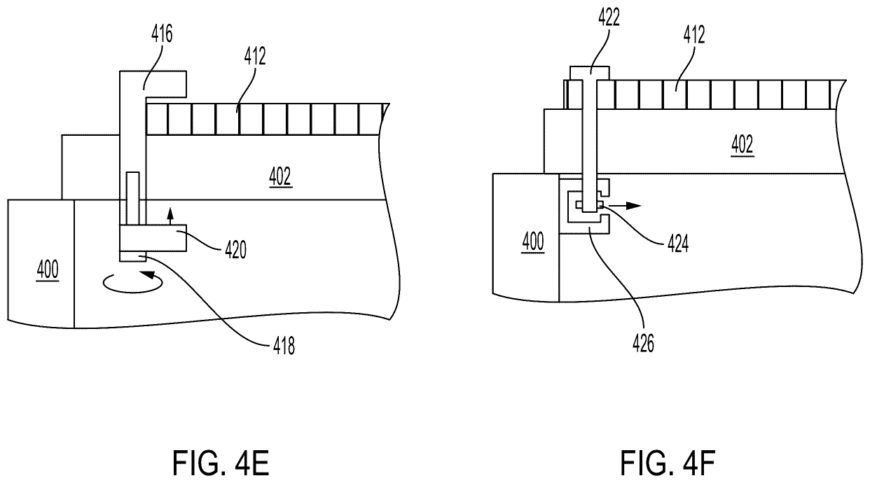

FIG. 4A illustrates a cross-sectional view of a truck bed 400, according to some aspects. The truck bed 400 may be equipped with a tonneau cover 402. The tonneau cover 402 may be attached to the truck bed 400 using a system having a rigid tonneau holder or rail 404 connected to the truck bed 400. The rail 404 may be fitted around a width of the end of the tonneau cover 402 and may clamp to or otherwise attach to the tonneau cover 402. The rail 404 may be a rigid material shaped to accept the edge of the tonneau cover 402 or may be a compliant material. The tonneau cover 402 may be removably attached to the rail 404 via a latch or other similar mechanism. A lift mechanism 408 may attach to the rail 404 and allow one or both sides of the tonneau cover 402 to be raised up from the top of the truck bed 400. A cab seal 410 may extend from the tonneau cover 402 and/or the rail 404 to the truck bed 400 and may be configured to maintain water-proofing integrity of the tonneau cover 402 regardless of whether the tonneau cover 402 is raised, lowered and/or tilted. The tonneau cover 402 may have multiple solar cells 412 attached to a top surface of the tonneau cover 402. The tonneau cover 402 may be foldable at one or more hinge points 414, which may run the length of the tonneau cover 402, as shown in FIG. 4A, or may run the width of the tonneau cover 402. Rails 406 may be located within the truck bed 400 and may be connected to the tonneau cover 402. The cab seal 410 may run from the rails 404 to the rails 406, and the lift mechanism 408 may extend from the rails 404 to the rails 406.

As shown in FIG. 4A, the tonneau cover 402 may be raised and/or tilted via the lift mechanism 408 to angle the top surface of the tonneau cover 402 containing the solar cells 412. The cab seal 410 may be able to be extended, as shown on the right side of FIG. 4A, or be retracted or folded, as shown on the left side of FIG. 4A. The cab seal 410 may be a flexible or extendable material that can stretch and compress according to whether it is being extended or not, or the cab seal 410 may be a rubber-like material that can fold together like an accordion when the tonneau cover 402 is in a nominal position and become elongated when the tonneau cover 402 is in a raised position. The tonneau cover 402 may be attached to the truck bed to accommodate the cab seal 410 between the side of the truck bed 400 and the edge of the tonneau cover 402. Whether the cab seal 410 is extended or retracted may correlate with whether the lift mechanism 408 is raised, as shown on the right side of FIG. 4A, or lowered, as shown on the left side of FIG. 4A. The lift mechanism 408 may be any mechanism capable of raising, lowering, and tilting the tonneau cover 402, such as a piston, a gas spring, a linear screw with a worm gear, or any other mechanism that can be raised, lowered, and tilted electrically, mechanically, or by hand, such as a solid kickstand or other mechanism that may be used to prop up one side of the tonneau cover 402. The cab seal 410 may connect from an edge of the truck bed 400 to the rails 404 that are attached to an edge of the tonneau cover 402. The lift mechanism 408 may connect from the rails 404 attached to edges of the tonneau cover 402 to the rails 406 located within the truck bed 400. The rails 406 may be interior mounting rails or other features built into the interior side of the truck bed 400 or may be hardware fixed or otherwise attached to the truck bed 400 for at least the purpose of attaching to the tonneau cover 402.

The hinge points 414 of the tonneau cover 402 may be used to fold the tonneau cover 402 during installation or when not in use. The hinge points 414 may align with gaps in the solar cells 412 so that the tonneau cover 402 can be folded at the hinge points 414 without interference from the solar cells 412. The solar cells 412 may be attached to the tonneau cover 402 via an adhesive or via one or more clamps, screws, bolts, or other attachment mechanisms. The solar cells 412 may be removably attached to the tonneau cover 402 or may be permanently attached. The hinge points 414 may run front-to-back along the length of the tonneau cover 402, as shown in FIG. 4A, allowing the tonneau cover 402 to be folded left to right or right to left. In other instances, the hinge points 414 may run side-to-side across the width of the tonneau cover 402, allowing the tonneau cover 402 to be folded front-to-back or back-to-front.

FIG. 4B illustrates a more detailed view of the tonneau cover 402 with solar cells 412 attached to the side of the truck bed 400. The tonneau cover 402 is attached to the rigid tonneau holder or rail 404. The tonneau cover 402 also connects to the rail 406 via a tonneau latch mechanism 401 that is a part of the tonneau cover 402. The tonneau latch mechanism 401 may have a movable latch portion 403 that is connected to a spring 405. The movable latch portion 403 may connect to a receiving portion 407 of the rail 406, and movement of the spring 405 may allow the movable latch portion 403 to removably connect the tonneau cover 402 to the rail 406 at the receiving portion 407. The seal 410 may also run from the rail 404 to the rail 406, waterproofing the connection of the tonneau cover 402 to the truck bed 400. Within the interior of the truck bed 400 there may additionally be an accessory rail 409 configured to connect to a variety of truck bed accessories. As shown in FIG. 4B, the accessory rail 409 may be on a mounting area 411 that may be secured to the side of the truck bed 400 via a bolt 413.

FIG. 4C illustrates the tonneau cover 402 with solar cells 412 attached to the truck bed 400 via the rails 404 and the rails 406. The tonneau latch mechanism 401 of the tonneau cover 402 is shown to have the movable latch portion 403 inserted into the receiving portion 407 of the rail 406 in order to removably connect the tonneau cover 402 to the truck bed 400. The seal 410 is shown connecting from the rail 404 to the rail 406. The lift mechanism 408 is not shown in an extended position. Therefore, seal 410 is shown in a collapsed position. The seal 410 may be an extendable or flexible material and may collapse in an accordion-like shape, as shown, when the lift mechanism 408 is not extended to raise the side of the tonneau cover 402 where the seal 410 is located.

FIG. 4D illustrates the tonneau cover 402 with solar cells 412 attached to the truck bed 400 via the rails 404 and the rails 406. The tonneau latch mechanism 401 of the tonneau cover 402 is shown to have the movable latch portion 403 inserted into the receiving portion 407 of the rail 406 in order to removably connect the tonneau cover 402 to the truck bed 400. The seal 410 is shown connecting from the rail 404 to the rail 406. The lift mechanism 408 is shown in an extended position. Therefore, seal 410 is shown in an extended or stretched position. The seal 410 may be an extendable or flexible material and extend or stretch to span the gap between the rail 404 and the rail 406 when the lift mechanism 408 is extended to raise the side of the tonneau cover 402 where the seal 410 is located.

FIG. 4E illustrates a clamp-style mechanism for removably attaching the solar cells 412 to the tonneau cover 402. A clamp 416 may be used to clamp the solar cells 412 to the tonneau cover 402. A screw 418 may be used to raise and lower an interior clamp section 420 that is configured to clamp the solar cells 412 to the tonneau cover 402 when the interior clamp section 420 is raised via tightening of the screw 418. Other clamp mechanisms may also be used, including spring clamps or lever activated clamps. The tonneau cover 402 may be attached to the truck bed 400 via traditional attachment or installation means, including latches, clamps, and rails. The screw 418 may be located on the underneath of the tonneau cover 402 such that the solar cells 412 may not be removed when the truck bed hatch is closed and locked. Access to the screw 418 and the interior clamp section 420 required to loosen the clamp 416 and detach the solar cells 412 may be prevented or prohibited when the truck bed 400 is closed and locked, thus providing theft-protection for the solar cells 412.

FIG. 4F illustrates a pin-style mechanism for attaching the solar cells 412 to the tonneau cover 402. A bolt 422 may be used to bolt the tonneau cover 402 and the solar cells 412 to truck bed rails 426. A pin 424 may be used to pin the bolt 422 through the rails 426 to secure the tonneau cover 402 and the solar cells 412 in place. The bolt 422 may extend through the solar cells 412 and the tonneau cover 402 as well as through an upper portion of the truck bed rails 426. The pin 424 may extend through the bolt 422 or otherwise attach to the bolt 422 in order to securely fasten the bolt 422 to the truck bed rails 426. The pin 424 and the truck bed rails 426 may be located underneath the tonneau cover 402 and within the truck bed 400 such that when the truck bed hatch is closed and locked, access to the pin 424 required to release the tonneau cover 402 and the solar cells 412 is prevented, providing theft-protection for the tonneau cover 402 and the solar cells 412. The bolt 422 may extend through the rail 426 as shown in FIG. 4C, or may extend only through the tonneau cover 402 before it is pinned with the pin 424.

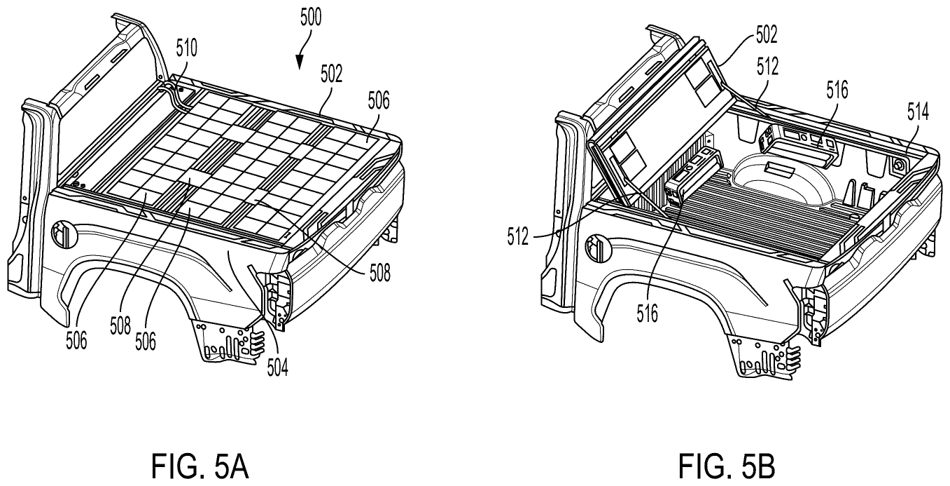

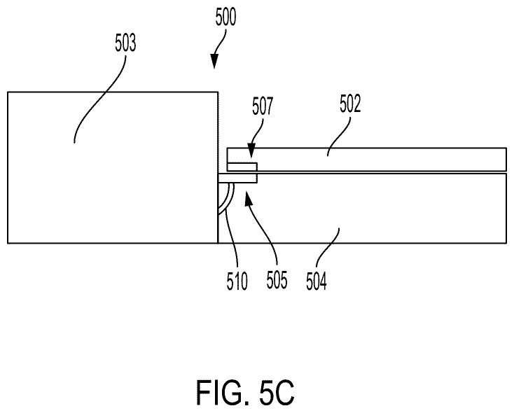

FIG. 5A illustrates a back of a truck 500 with an exemplary solar tonneau cover 502 covering a truck bed 504. As illustrated in FIG. 5A, the solar tonneau cover 502 is extended flat across the top of the truck bed 504. The tonneau cover 502 may have two or more solar panels 506 connected by one or more hinges 508. The tonneau cover 502 may connect to the truck electronics through a wire harness 510. The wire harness 510 may route energy generated by the solar tonneau cover 502 into a battery located in the cab or the bed of the truck 500. The wire harness 510 may be positioned within the enclosed space of the truck cab under the tonneau cover 502 when the tonneau cover 502 is closed over the truck bed, so that the wire harness 510 is protected from water, debris, etc. In some instances, a switch contact pad (see FIG. 5C) may be located on an underside of the tonneau cover 502 and may mate with another contact pad on a top of an edge of the truck bed 504.

FIG. 5B illustrates the back of the truck 500 with the solar tonneau cover 502 folded up. When the tonneau cover 502 is folded, the tonneau cover 502 may be stabilized by one or more rods 512. Within the truck bed 504, the truck 500 may have a power port 514 where the user of the vehicle is able to connect an electrically powered device to the power port 514 and use power generated by the solar panels 506. The power port 514 may be a 12V DC port or plug that a user of the vehicle is able to connect various electrically powered accessories to, such as power tools or other powered equipment, lights, radio, or other external electrical devices. The solar panels 506 may be directly integrated with the power port 514. The wire harness or other power routing mechanisms may route power generated by the solar panels 506 directly into the vehicle's internal 12V battery, which may be integrated with the power port 514 to supply power to external electrical devices.

One or more external batteries 516 may also be located within the truck bed 504. The truck bed 504 may have one or more designated locations built into the truck bed 504 to house or otherwise support the external batteries 516. The external batteries 516 may also be placed anywhere within the truck bed 504 or the truck cab. The solar panels 506 may connect to the external batteries 516 via the wire harness 510 or other energy routing methods in order to capture and store energy generated by the solar panels 506 within the external batteries 516. The external batteries 516 may be used to capture and store power generated by the solar panels 506 even when the truck 500 is powered off.

FIG. 5C illustrates the truck 500 of FIGS. 5A and 5B with the truck bed 504 and a cab 503. The tonneau cover 502 may connect to the wire harness 510 through an internal switch contact 505 located within the truck bed 504. An external switch contact 507 may be located external to the truck bed 504. The internal switch contact 505 and the external switch contact 507 may mate to allow a transfer of energy from the tonneau cover 502 through the wire harness 510. The wire harness 510 may then connect to one or more batteries within the truck 500.

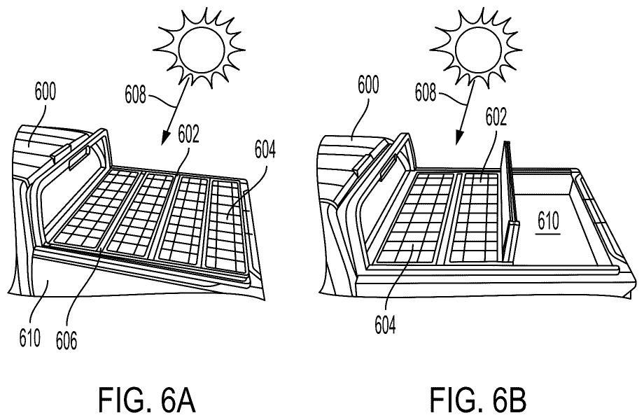

FIG. 6A illustrates a truck 600 with a solar tonneau cover 602 attached to a truck bed 610. The solar tonneau cover 602 has solar panels 604 connected together by hinges 606. The tonneau cover 602 may have four solar panels 604, as shown in FIG. 6A, or may have more or fewer total solar panels. Traditional tonneau covers may have three folding segments and two hinges. The solar panels 604 are configured to convert sunlight 608 into electricity. When fully extended, or when all of the solar panels 604 are laid flat across the back of the truck 600, the tonneau cover 602 may cover the entirety of the truck bed 610.

FIG. 6B illustrates the truck 600 with the solar tonneau cover 602 partially folded, allowing access to an interior of the truck bed 610. The truck bed 610 may house one or more external batteries or contain a power port which a user of the vehicle can connect external electrical devices to in order to power such devices. The solar tonneau cover 602 may be at least partially in use converting sunlight 608 into usable power while at least partially allowing access to the interior of the truck bed 610, as shown in FIG. 6B.

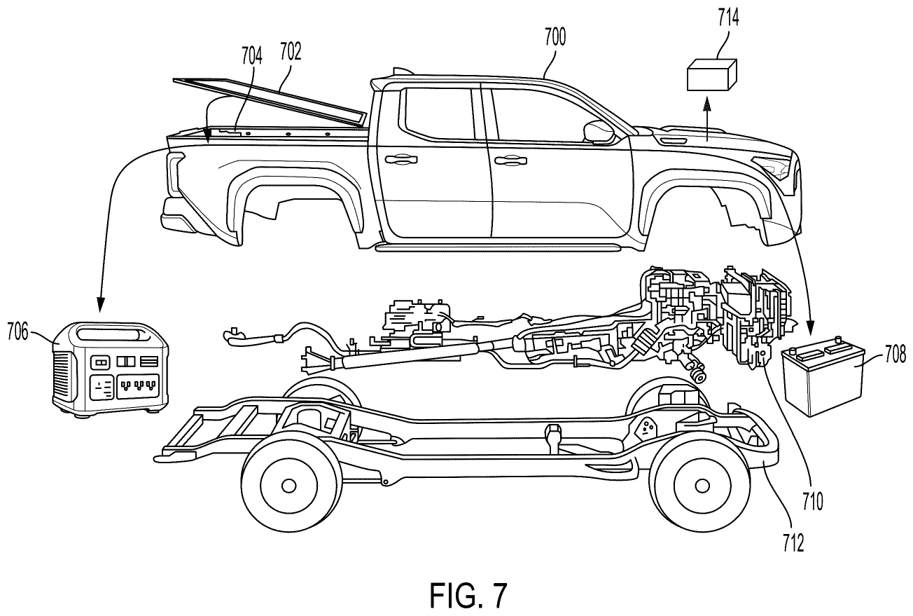

FIG. 7 illustrates a partially exploded view of a vehicle 700 with a solar tonneau cover 702 attached to a truck bed 704. The vehicle 700 has an external removable battery 706 and an internal 12V battery 708. The vehicle also has a power train 710 and a wheelbase 712. The solar tonneau cover 702 is capable of integrating with the vehicle's 12V battery 708. The solar tonneau cover 702 can provide energy to the 12V battery to provide energy for certain accessory functions like playing music when the vehicle is parked or turned off, or having the vehicle lights on. By providing energy to the battery 708, the solar tonneau cover 702 may limit or prevent the parasitic draw on the battery 708 that using certain accessory functions may typically create when used especially when the vehicle engine is powered off. The external battery 706 may be located in the truck bed 704, and may have a specified dock or other housing within the truck bed 704. The external battery 706 may alternatively be located within the cabin of the vehicle 700. The external battery 706 may be wired to the solar tonneau cover 702 in order to collect and store generated energy and provide something a user of the vehicle 700 can connect to in order to use that energy. A wire harness system may pass through the body of the vehicle 700 to connect solar panels of the tonneau cover 702 to the external battery 706 located within the truck cab. The external battery 706 could be disconnected from and removed from the vehicle 700 and taken elsewhere to continue to power an electrical device away from the vehicle 700.

In some embodiments, the vehicle 700 may be a hybrid or fully electric vehicle. The solar tonneau cover 702 may be able to integrate with the electrified vehicle power train such that the solar panels of the tonneau cover 702 are able to contribute to the overall vehicle range.

In some aspects, an ECU 714 is configured to decide where to route the energy generated by the solar tonneau cover. On an internal combustion engine vehicle, the electricity or power generated can supply or power the standard 12V battery of the vehicle and/or an accessory battery pack. On a hybrid or battery electric vehicle (BEV), the generated power can be routed to a hybrid battery, a BEV battery, a 12V battery, an external battery, or other batteries. The ECU 714 may be able to monitor various battery levels and use levels and decide where power should be routed and stored.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A tonneau cover for a truck, comprising:
at least one solar panel removably attached to a top portion of the tonneau cover and configured to be portable for placement external to the truck while remaining electrically connected to charge a battery and to convert sunlight into electricity;
one or more sensors configured to detect the sunlight and determine a direction of the sunlight relative to the at least one solar panel;
an electronic control unit (ECU) configured to receive data from the one or more sensors and determine a positioning of the at least one solar panel based on the detected direction of the sunlight;
an adjustment mechanism configured to automatically adjust the at least one solar panel based on the determined positioning to continuously track the direction of the sunlight and dynamically adjust an angle and tilt of the at least one solar panel while the truck is being driven; and
an electrical wire connecting the at least one solar panel to the battery of the truck, the electrical wire being configured to route the electricity generated by the at least one solar panel to the battery.

2. The tonneau cover of claim 1, further comprising a tonneau cover adjustment mechanism configured to raise or lower one or more locations along a perimeter of the tonneau cover to place the tonneau cover in a desired orientation for capturing sunlight.

3. The tonneau cover of claim 1, wherein the adjustment mechanism is manually adjustable.

4. The tonneau cover of claim 1, wherein the adjustment mechanism is powered by a motor.

5. The tonneau cover of claim 1, wherein the ECU is further configured to monitor charge levels of multiple batteries including the battery and an auxiliary battery, and to route the electricity generated by the at least one solar panel to one of the multiple batteries based on the monitored charge levels.

6. The tonneau cover of claim 1, wherein the truck has an internal combustion engine and wherein the battery is an internal 12V battery of the truck used to start the internal combustion engine and power auxiliary features of the truck.

7. The tonneau cover of claim 1, wherein the truck is a hybrid or electric vehicle and wherein the battery is used to power the truck.

8. The tonneau cover of claim 1, wherein the battery is a removable auxiliary battery.

9. The tonneau cover of claim 8, wherein the battery is located in a dedicated compartment in a bed of the truck.

10. The tonneau cover of claim 1, further comprising two or more solar panels connected together by one or more hinges, wherein the tonneau cover is able to be bent along an axis that runs through the one or more hinges.

11. A system for converting solar energy into electricity on a vehicle, the system comprising:
a truck with a truck bed and a truck cabin;
a tonneau cover attached to the truck bed;
one or more solar panels attached to a top portion of the tonneau cover, the one or more solar panels configured to be portable for placement external to the truck while remaining electrically connected to charge a battery;
one or more sensors configured to detect sunlight and determine a direction of the sunlight relative to the one or more solar panels;
an electronic control unit (ECU) configured to receive data from the one or more sensors and determine a positioning of the one or more solar panels based on the detected direction of the sunlight;
an adjustment mechanism configured to automatically adjust the one or more solar panels based on the determined positioning to continuously track the direction of the sunlight and dynamically adjust an angle and tilt of the one or more solar panels while the truck is being driven;
an auxiliary battery located within the truck bed or the truck cabin and configured to store energy generated by the one or more solar panels and provide power to auxiliary electrical devices; and
an internal battery configured to store energy generated by the one or more solar panels and supply power to a power port located within the truck bed or the truck cabin; and an electrical wire that connects the solar panels to the auxiliary battery and the internal battery.

12. The system of claim 11, wherein the truck has an internal combustion engine and the internal battery is a standard 12V vehicle battery.

13. The system of claim 11, wherein the truck is a hybrid or electric vehicle with an electrified power train and the internal battery provides power to the electrified power train.

14. The system of claim 11, wherein the one or more solar panels are removably attached to the tonneau cover via one or more clamps.

15. The system of claim 14, wherein the one or more clamps are located underneath the tonneau cover such that access to the one or more clamps is prohibited when the truck bed is closed and locked.

16. A method for transforming sunlight into usable electricity for a truck, comprising:
attaching solar panels to a top portion of a tonneau cover, the solar panels being configured to be portable for placement external to the truck while remaining electrically connected to charge a battery;
attaching the tonneau cover to a bed of the truck;
detecting a direction of the sunlight relative to the solar panels using one or more sensors;
positioning the solar panels in sunlight to allow the solar panels to absorb the sunlight;
automatically adjusting an angle and tilt of the solar panels based on the detected direction of the sunlight to continuously track the direction of the sunlight while the truck is being driven;
converting the sunlight into electricity via the solar panels;
routing the electricity through an electrical wire to the battery housed within the truck; and
accessing the electricity via a 12V DC power port connected to the battery and located within the bed of the truck.

17. The method of claim 16, wherein the attaching the solar panels to the tonneau cover includes attaching the solar panels to a detachable panel portion of the tonneau cover using an adhesive.

18. The method of claim 16, wherein the attaching the solar panels to the tonneau cover includes removably attaching the solar panels to the tonneau cover using an attachment mechanism that holds the solar panels on the tonneau cover.

19. The method of claim 18, wherein the attachment mechanism is accessible from underneath the tonneau cover such that the attachment mechanism is closed and locked within the truck bed when the truck bed is closed and locked.

20. The method of claim 16, wherein the positioning the solar panels in sunlight includes raising at least one corner of the tonneau cover to place the solar panels at an angle in order to maximize the sunlight absorbed by the solar panels.
